(19) United States
(12) Patent Application Publication
(10) Pub. No.: US 2026/0312284 A1
(43) Pub. Date: Oct. 8, 2026

(54) ANTENNA DEVICE AND ELECTRONIC DEVICE

(71) Applicant: UNIVERSAL SCIENTIFIC INDUSTRIAL ( SHANGHAI ) CO., LTD., SHANGHAI (CN)

(72) Inventor: KUAN-HSING LI, SHANGHAI (CN)

(21) Appl. No.: 19/558,547

(22) Filed: Mar. 6, 2026

(30) Foreign Application Priority Data
Apr. 3, 2025 (CN) 202510421118.X

(51) Int. Cl. H01Q 1/52; H01Q 1/42; H01Q 5/307

(52) U.S. Cl. CPC H01Q 1/526; H01Q 1/42; H01Q 5/307

(57) ABSTRACT

An antenna device and an electronic device. The antenna device includes a substrate assembly, a first metal bending structure, a shielding cover and a frame. The substrate assembly includes a plurality of metal vias and at least one signaling metal via. The first metal bending structure includes a first portion and a second portion. The shielding cover is disposed on the substrate assembly and shields the first metal bending structure. The frame is disposed on the substrate assembly. The frame is connected to the shielding cover. The substrate assembly is connected to a control circuit to receive an antenna signal. The antenna signal is transmitted to the first metal bending structure through a signal metal through hole of the substrate assembly to adjust a transmission direction for transmission.

### CROSS-REFERENCE TO RELATED PATENT APPLICATION

This application claims the benefit of priority to Patent Application No. 202510421118.X, filed on Apr. 3, 2025, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an antenna and an electronic device, and more particularly to an antenna and an electronic device for adjusting the transmission direction.

### BACKGROUND OF THE DISCLOSURE

As mobile communication networks evolve to the current 5G generation, in order to expand bandwidth for growing digital applications, in addition to the limited bandwidth of sub-6 GHZ in frequency range 1 (FR1), the practical application and popularization of the millimeter wave band in frequency range 2 (FR2) is also very important. 5G millimeter wave RF modules on mobile devices are usually designed with packaged antennas (Antenna in Package, AiP). The antenna array is set on the circuit layer below the substrate of the millimeter wave RF module, and is implemented in the form of a patch antenna to save cost and reduce volume. However, the disadvantages of the packaged antenna (AiP) are poor antenna efficiency and effective bandwidth. When the frequency is higher, such as the bandwidth n263 (Band n263) which has been extended to 71 GHz, the patch antenna with the conductor on the printed circuit board as the radiator will have a more obvious loss of the substrate medium of the printed circuit board at high frequencies, resulting in worse antenna efficiency.

In smartphone applications, since the above-mentioned packaged antenna (AiP) has an antenna radiation direction toward the top of the antenna body (boresight direction), it is usually installed on a side of the mobile device so that the antenna signal can be transmitted to the side of the mobile device. Since the side thickness of mobile devices is limited, this configuration will greatly limit the width of the packaged antenna (AiP), and has poor heat dissipation performance.

### SUMMARY OF THE DISCLOSURE

In response to the above-referenced technical inadequacies, the present disclosure provides an antenna device. The antenna device includes a substrate assembly, a first metal bending structure, a shielding cover, and a frame. The substrate assembly includes a plurality of metal vias and at least one signaling metal via. The first metal bending structure includes a first portion and a second portion. The second portion is connected to the first portion, the second portion is parallel to the substrate assembly, and the first portion is connected to and disposed on the substrate assembly. The shielding cover is disposed on the substrate assembly and shielding the first metal bending structure. A side of the shielding cover adjacent to the first portion of the first metal bending structure is closed, and another side of the shielding cover away from the first portion of the first metal bending structure is open and has an opening. The frame is disposed on the substrate assembly. The frame is connected to the shielding cover. The substrate assembly is connected to a control circuit to receive an antenna signal, and the antenna signal is transmitted to the first metal bending structure through a signaling metal via of the substrate assembly to adjust a transmission direction for transmission.

In order to solve the above-mentioned problems, one of the technical aspects adopted by the present disclosure is to provide an electronic device.

An electronic device includes a control circuit and at least one antenna device. The at least one antenna device is electrically connected to the control circuit to receive an antenna signal. The at least one antenna device includes a substrate assembly including a plurality of metal vias and at least one signaling metal via; a first metal bending structure including a first portion and a second portion, the second portion being connected to the first portion of the first metal bending structure and being parallel to the substrate assembly, and the first portion being connected to and disposed on the substrate assembly; a shielding cover being disposed on the substrate assembly and shielding the first metal bending structure, a side of the shielding cover adjacent to the first portion of the first metal bending structure being closed, and another side of the shielding cover away from the first portion of the first metal bending structure being open and having an opening; and a frame being disposed on the substrate assembly, the frame being connected to the shielding cover. The substrate assembly is connected to the control circuit to receive an antenna signal, and the antenna signal is transmitted to the first metal bending structure through the signaling metal via of the substrate assembly to adjust the transmission direction for transmission.

In order to solve the above-mentioned problems, yet another one of the technical aspects adopted by the present disclosure is to provide an electronic device. The electronic device includes a first antenna device and a second antenna device. The first antenna device is electrically connected to the control circuit to receive an antenna signal. The second antenna device is electrically connected to the control circuit to receive the antenna signal. The first antenna device and the second antenna device each include: a substrate assembly including a plurality of metal vias and at least one signaling metal via, a first metal bending structure including a first portion and a second portion, a shielding cover being disposed on the substrate assembly and shielding the first metal bending structure, and a frame being disposed on the substrate assembly, the frame being connected to the shielding cover. The second portion of the first metal bending structure is connected to the first portion of first metal bending structure. The second portion is parallel to the substrate assembly, and the first portion of the first metal bending structure is connected to and disposed on the substrate assembly. The antenna signal is transmitted to the first metal bending structure through the signal metal through hole of the substrate assembly to adjust the transmission direction for transmission. A side of the shielding cover close to the first portion of the first metal bending structure is closed, and another side of the shielding cover away from the first portion of the first metal bending structure is open and has an opening. The antenna signal of the first antenna device is transmitted along a first direction, and the antenna signal of the second antenna device is transmitted along a second direction, and the first direction and the second direction are different directions.

Therefore, the antenna device of the present disclosure utilizes a shielding cover design that is made by surface mounting technology to convert antenna signals (RF signals) from inner layer circuits of the multi-layer circuit board in the substrate assembly to a waveguide structure on the substrate assembly. Next, the antenna device of the present disclosure converts the electromagnetic wave (electric field vector) of the antenna signal to be radiated directly outward in the horizontal direction, and provides performance that is superior to that of an antenna-in-package.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an antenna device according to a first embodiment of the present disclosure;

FIG. 2 is a schematic top view of the antenna device according to the first embodiment of the present disclosure;

FIG. 3 is a schematic side view of the antenna device according to the first embodiment of the present disclosure;

FIG. 4 is a front view of the antenna device according to the first embodiment of the present disclosure;

FIG. 5 is a schematic view of an electric field vector along the cross-section line VI-VI in FIG. 2;

FIG. 6 is a schematic view of the electric field vector along the cross-section line V-V in FIG. 2;

FIG. 7 is a schematic side view showing an electric field intensity distribution of the antenna device according to the first embodiment of the present disclosure;

FIG. 8 is a schematic top view of the electric field intensity distribution of the antenna device according to the first embodiment of the present disclosure;

FIG. 9 is an S-parameter simulation diagram of the antenna device according to the first embodiment of the present disclosure;

FIG. 10 is a schematic diagram of an antenna device in accordance with the first embodiment of the present disclosure in combination with a millimeter wave module.

FIG. 11 is another schematic view of the antenna device in accordance with the first embodiment of the present disclosure in combination with the millimeter wave module; and

FIG. 12 is a schematic view of an electronic device according to a second embodiment of the present disclosure; and

FIG. 13 is a schematic view of an electronic device according to a third embodiment of the present disclosure; and

FIG. 14 is a schematic view of an electronic device according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

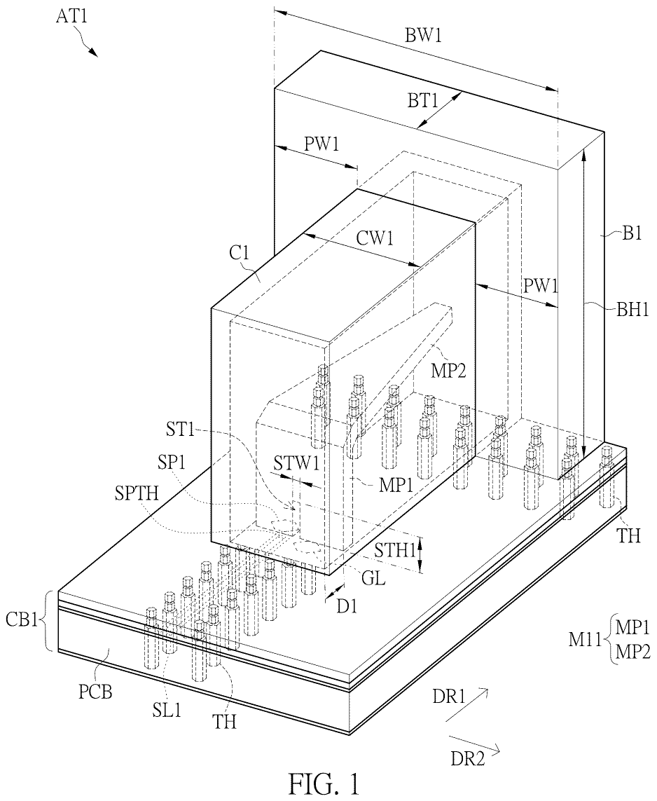

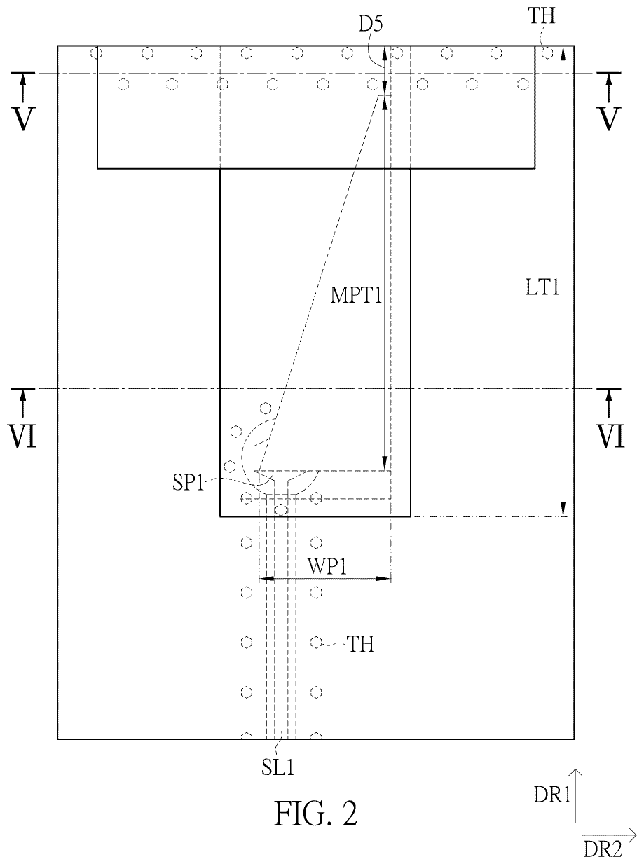

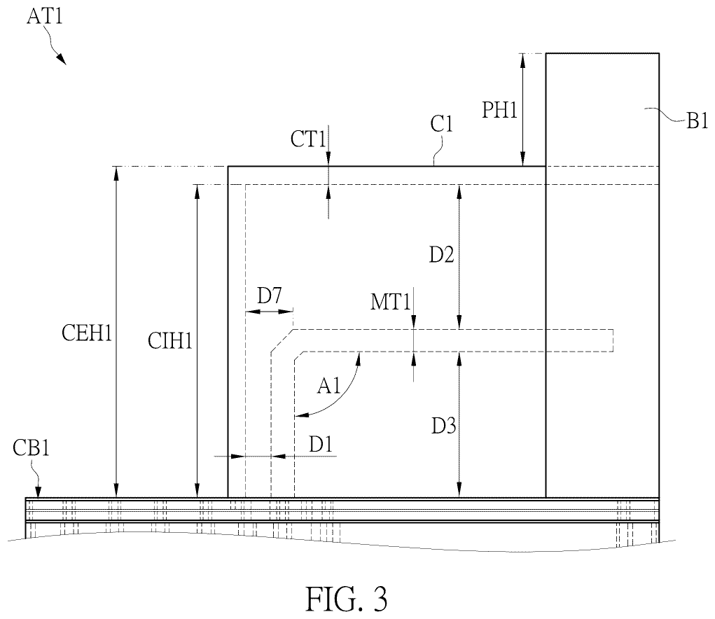

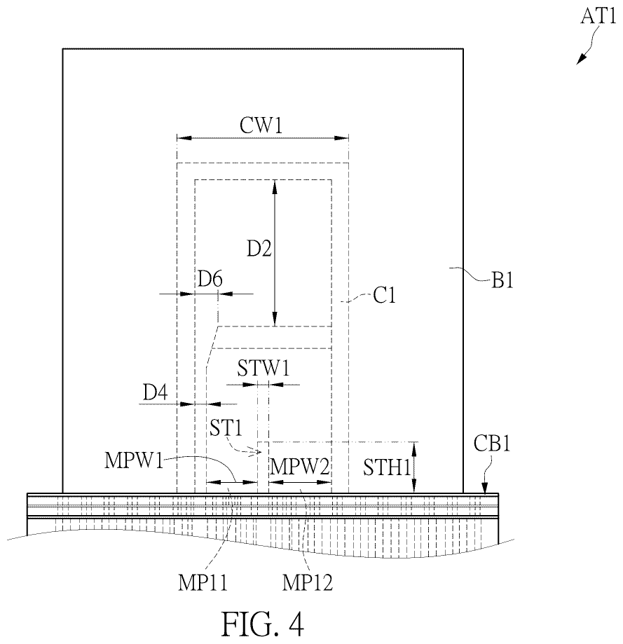

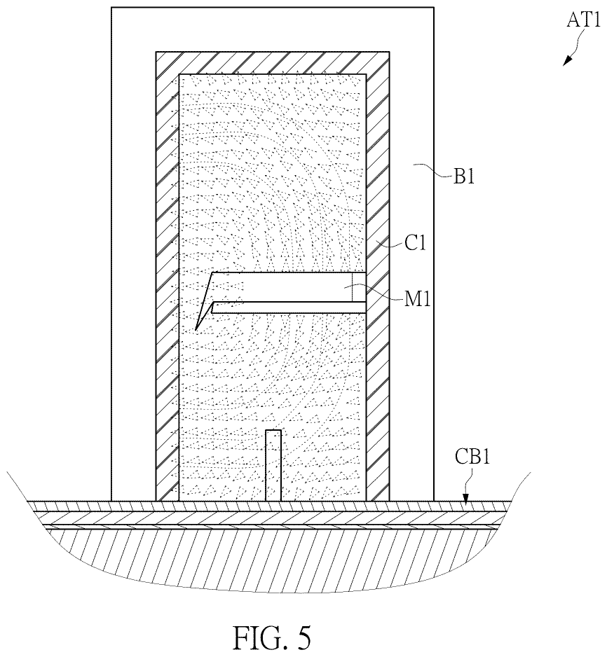

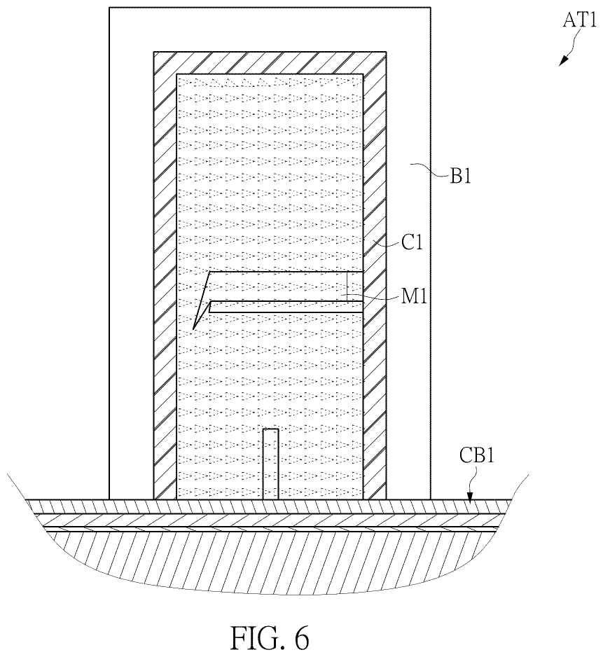

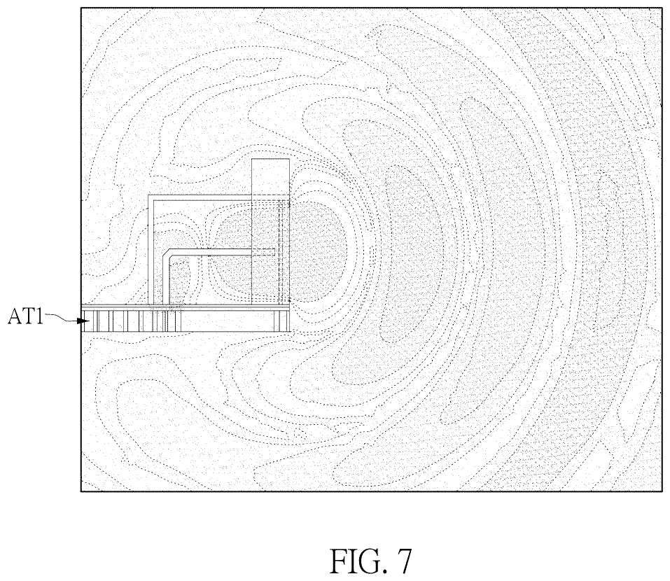

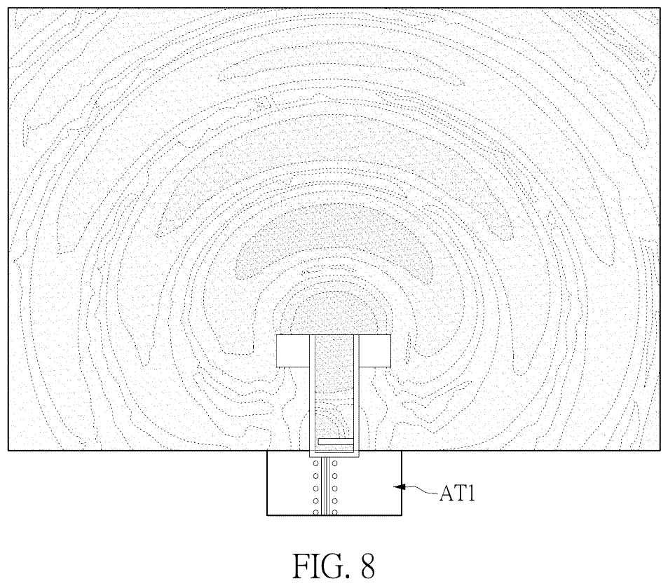

Referring to FIG. 1 to FIG. 8, FIG. 1 is a schematic view of an antenna device according to a first embodiment of the present disclosure, FIG. 2 is a schematic top view of the antenna device according to the first embodiment of the present disclosure, FIG. 3 is a schematic side view of the antenna device according to the first embodiment of the present disclosure, FIG. 4 is a front view of the antenna device according to the first embodiment of the present disclosure, FIG. 5 is a schematic view of an electric field vector along the cross-section line VI-VI in FIG. 2, FIG. 6 is a schematic view of the electric field vector along the cross-section line V-V in FIG. 2, FIG. 7 is a schematic side view showing an electric field intensity distribution of the antenna device according to the first embodiment of the present disclosure, and FIG. 8 is a schematic top view of the electric field intensity distribution of the antenna device according to the first embodiment of the present disclosure.

In this embodiment, an antenna device AT1 is provided.

The antenna device AT1 includes a substrate assembly CB1, a first metal bending structure M11, a shielding cover C1 and a frame B1.

The first metal bending structure M11 includes a first side and a second side. The first side of the first metal bending structure M11 is disposed on one side of the substrate assembly CB1. The second side of the first metal bending structure M11 extends toward the other side of the substrate assembly CB1.

The shielding cover C1 is disposed on the substrate assembly CB1 and shields the first metal bending structure M11.

The frame B1 is disposed on the other side of the substrate assembly CB1. The frame B1 is connected to the shielding cover C1.

The substrate assembly CB1 is connected to a control circuit to receive an antenna signal. The antenna signal is transmitted to the first metal bending structure M11 through the signaling metal through hole SPTH of the substrate assembly CB1 for transmission.

The first metal bending structure M11 includes a first portion MP1 and a second portion MP2. The second portion MP2 is connected to the first portion MP1. An angle A1 is defined between the first portion MP1 and the second portion MP2. In this embodiment, the angle between the first portion MP1 and the second portion MP2 is 90 degrees. Therefore, the second portion MP2 is parallel to the substrate assembly CB1. In addition, the first portion MP1 is vertically connected to and disposed on the substrate assembly CB1.

Furthermore, the second portion MP2 of the first metal bending structure M11 is a triangle or a trapezoid. That is, a width value of the second portion MP2 decreases gradually. The width of the second portion MP2 gradually decreases from the closed side of the shielding cover C1 to the open side of the shielding cover C1.

In addition, the length of the long side distance MPT1 of the second portion MP2 is less than or equal to a sum of a length of the shielding cover C1 and a width of the frame B1. That is, the first metal bending structure M11 is completely contained in the shielding cover C1 and the frame B1.

The first portion MP1 of the first metal bending structure M11 includes a first notch ST1. The first notch ST1 is disposed on a side of the first portion MP1 connected to the substrate assembly CB1. The first portion MP1 is divided into two parts based on the first notch ST1, that is, the first portion MP1 includes a first part MP11 and a second part MP12. The second portion MP12 is connected to an inner wall of the shielding cover C1 and a ground layer GL.

In addition, referring to FIG. 2, a long side of the second portion MP2 of the first metal bending structure M11 is also connected to the inner side wall of the shielding cover C1.

The side of the shielding cover C1 adjacent to the first portion MP1 of the first metal bending structure M11 is closed. The other side of the shielding cover C1 away from the first portion MP1 of the first metal bending structure M11 (the side joined to the frame B1) is open and has an opening. Furthermore, the opening of the second side of the shielding cover C1 is the same size as the inner cavity of the shielding cover C1.

In this embodiment, the shielding cover C1 can be set on the substrate assembly CB1 by the surface mount technology (SMT). Furthermore, the shielding cover C1 can be made of metal material.

The substrate assembly CB1 includes a multi-layer circuit board PCB, a soldering pad SP1, at least one signaling metal via SPTH and a plurality of metal vias TH. The at least one signaling via SPTH and the plurality of metal vias TH are disposed in the multi-layer circuit board PCB. The signal strip line SL1 is arranged on the middle layer of the multi-layer circuit board PCB to be connected to the topmost soldering pad SP1 through the at least one signaling metal via SPTH. In addition, the top layer of the multi-layer circuit board PCB further includes a ground layer GL.

In this embodiment, the signal strip line is a radio frequency strip line. The signal strip line of the substrate assembly CB1 is connected to a control circuit (not shown) to receive an antenna signal. In this embodiment, the first part MP11 of the first portion MP1 of the first bending metal structure M11 is connected to the pad SP1 and the signaling metal via SPTH to receive the antenna signal. In this embodiment, the signal strip line SL1 is a strip line with an impedance of 50 ohms. The antenna signal is fed by a signal strip line SL1 with an impedance of 50 ohms, and then travels to the bottom of the shielding cover C1 with metal vias TH (ground vias) arranged on both sides, and then connected to the soldering pad SP1 on the top layer of the multi-layer circuit board PCB through the signaling metal via SPTH.

In addition, the plurality of metal vias TH of the substrate assembly CB1 are arranged on both sides of the multi-layer circuit board PCB. The plurality of metal vias TH on the first side of the substrate assembly CB1 are arranged along a first direction DR1 and arranged in pairs. The plurality of metal vias TH on the second side of the substrate assembly CB1 are arranged along a second direction DR2 and arranged in pairs. The first direction DR1 and the second direction DR2 are perpendicular to each other on the same plane.

The frame B1 includes a frame width BW1 and a frame height BH1. The shielding cover C1 includes a shielding cover width CW1 and a shielding cover height CEH1. The frame width BW1 is a sum of the shielding cover width CW1 and twice the predetermined width PW1. The frame height BH1 is a sum of the shielding cover height CEH1 and a predetermined height PH1. In this embodiment, a width value of the predetermined width PW1 is 1 mm. A height value of the predetermined height PH1 is 1 mm. The frame B1 also includes a frame thickness BT1. In this embodiment, the frame thickness is 1 mm. In this embodiment, the frame B1 is a U-shaped frame. The frame B1 can also be regarded as a metal ring, which is joined to the side of the shielding cover C1 having the opening.

In this embodiment, a height value of the shielding cover height CEH1 of the shielding cover C1 is 2.9 mm. A thickness value of the side wall thickness CT1 of the shielding cover C1 is 0.15 mm. An inner height CIH1 of the shielding cover C1 has a height value of 2.75 mm.

The first portion MP1 of the first metal bending structure M11 is spaced apart from the inner wall of the closed side of the shielding cover C1 by a distance D1, and the distance value of the distance D1 is 0.225 mm. That is, the first portion MP1 of the first metal bending structure M11 is not connected to the inner wall of the closed side of the shielding cover C1. However, the first portion MP1 and the second portion MP2 of the first metal bending structure M11 are connected to the inner wall of the other side of the shielding cover C1 (the inner wall adjacent to the closed side of the shielding cover C1 and the inner wall of the shielding cover C1 adjacent to the second portion MP12).

However, the first portion MP1 and the second portion MP2 of the first metal bending structure M11 are not connected to the inner side wall of the shielding cover C1 adjacent to the first part MP11. The first portion MP1 of the first metal bending structure M11 and the inner wall of the shielding cover C1 adjacent to the first part MP11 have a distance D4 therebetween. The distance D4 is 0.1 mm. Furthermore, a thickness value of a structure thickness MT1 of the first metal bending structure M11 is 0.2 mm.

In addition, the upper side of the second portion MP2 of the first metal bending structure M11 and the inner side wall of the shielding cover C1 have a distance D2 therebetween. The distance value of the distance D2 is 1.275 mm.

The lower side of the second portion MP2 of the first metal bending structure M11 and the substrate assembly CB1 have a distance D3 therebetween. The distance value of the distance D3 is 1.275 mm.

The second portion MP2 of the first metal bending structure M11 is a triangle or a trapezoid. That is, the end of the second portion MP2 may be a pointed structure or a flat-cut structure. The length of the second portion MP2 connected to the inner wall of the shielding cover C1 from the long side MPT1 is 3 mm. One end of the second portion MP2 does not extend beyond the frame B1.

In this embodiment, the end of the second portion MP2 and the border of the frame B1 have a distance D5 therebetween, and the distance value of the distance D5 is 0.4 mm. The second portion MP2 of the first metal bending structure M11 has a distance D6 from the inner wall of the shielding cover C1 at a side close to the first portion MP1, and the distance value of the distance D6 is 0.21 mm. In this embodiment, the shielding cover height CEH1 of the shielding cover C1 is 2.9 mm. A total length LT1 of the shielding cover C1 and the frame B1 is 3.775 mm.

In this embodiment, the second portion MP2 of the first metal bending structure M11 has a chamfered structure at a side adjacent to the first portion MP1. The first metal bending structure M11 and the inner wall of the first side of the shielding cover C1 have a distance D7 therebetween, and the distance value is 0.415 mm. A width WP1 of one side of the first portion MP1 connected to the substrate assembly CB1 is 1.1 mm. That is, the first portion MP1 will vertically extend to a certain height, and a chamfered structure will appear at the connection between the first portion MP1 and the second portion MP2.

The first notch ST1 of the first metal bending structure M11 includes a notch height STH1 and a notch width STW1. The height value of the notch height STH1 is 0.45 mm. The width value of the notch width STW1 is 0.1 mm. In this embodiment, the distance value, height value, and width value can be adjusted according to the actual requirements in proportion or according to the antenna signal frequency, and are not limited in the present disclosure.

Referring to FIG. 3, FIG. 4, FIG. 5 and FIG. 6, the antenna signal is transmitted through the substrate assembly CB1 and the first metal bending structure M11 and in the shielding cover C1. The transmission direction of the antenna signal is adjusted through the first metal bending structure M11 and the shielding cover C1. That is, the antenna signal is first adjusted under the guidance of the first metal bending structure M11 and the shielding cover C1. Next, the adjusted antenna signal is guided by the second portion MP2 of the first metal bending structure M11 to form an antenna signal with horizontal polarization.

As shown in the electric field vector diagram of the cross-section line IV-IV in FIG. 5, after the electromagnetic wave signal enters from the signal strip line SL1 in the inner layer, the energy is transmitted to the first metal bending structure M11 through the signaling metal through hole SPTH, and an adjusted electric field vector is formed under the protection of the shielding cover C1. As shown in the electric field vector diagram of the cross-section line V-V in FIG. 6, when the electric field moves along the first metal bending structure M11 toward the opening direction of the shielding cover C1, and the electric field is transmitted to approach the opening of the shielding cover C1, due to the gradually decreasing structural characteristics (triangle or trapezoid) of the second part MP2 of the first metal bending structure M11, the electric field will gradually change from a folded state to a horizontal polarization in a single direction (as shown in the electric field vector diagram of the section line V-V in FIG. 6, FIG. 7 and FIG. 8).

The configuration of the frame B1 (U-shaped metal ring) at the opening of the shielding cover C1 can avoid the diffraction and reflection effects of the electric field at the opening edge of the shielding cover C1, thereby reducing energy reflection, increasing the gain of the antenna device AT1 and improving the orientation.

In addition, reference is made to Table 1. Table 1 shows the radiation efficiency of the antenna device AT1 of this embodiment at various frequencies.

However, the aforementioned details are disclosed for exemplary purposes only, and are not meant to limit the scope of the present disclosure.

TABLE 1

| | | peak realized | radiation |
|---|---|---|---|
| | Frequency(GHz) | gain (dBi) | efficiency |
| 1 | 57.000000 | 6.01 | 0.94 |
| 2 | 60.000000 | 5.95 | 0.94 |
| 3 | 64.000000 | 6.37 | 0.94 |
| 4 | 68.000000 | 7.02 | 0.95 |
| 5 | 71.000000 | 7.12 | 0.95 |

As shown in Table 1, the peak realized gain of this embodiment can reach 5.95 dBi at 60 GHz. Without considering the mismatch at the feeding terminal, the radiation efficiency of the antenna device AT1 can reach 94%.

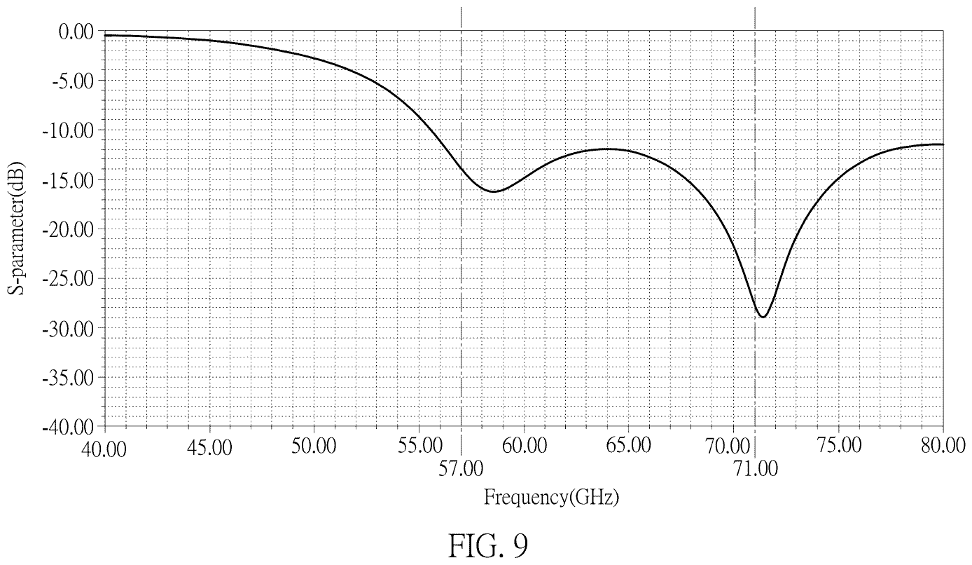

Referring to FIG. 9, FIG. 9 is an S-parameter simulation diagram of the antenna device according to the first embodiment of the present disclosure.

As shown in the S-parameter diagram of FIG. 9, the return loss (Return Loss) of the antenna device AT1 of this embodiment in FIG. 9 meets the requirements of more than 10 dB within the frequency band (57~71 GHZ) of n263 in the latest frequency range 2 (FR2), which means that the antenna device AT1 of this embodiment is very suitable for applications in 5G millimeter waves or higher frequency bands.

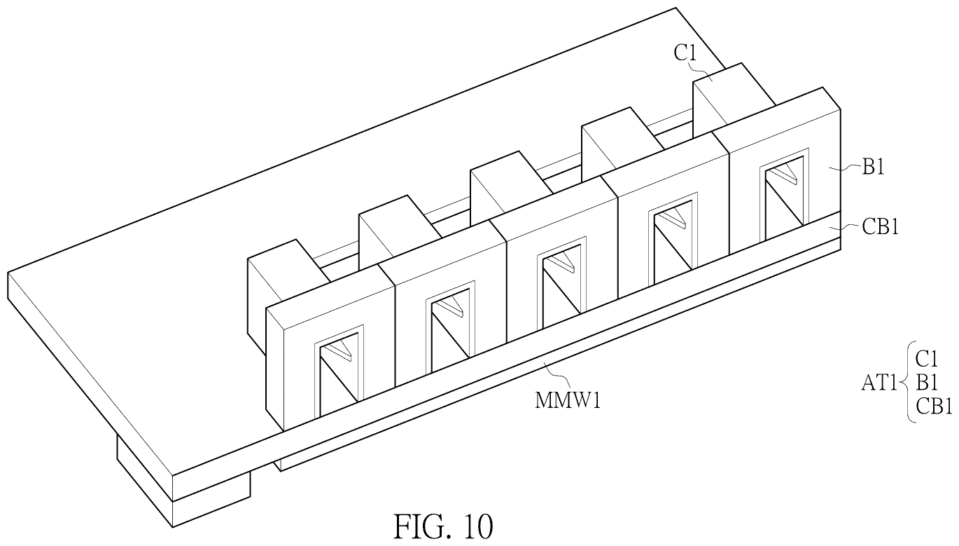

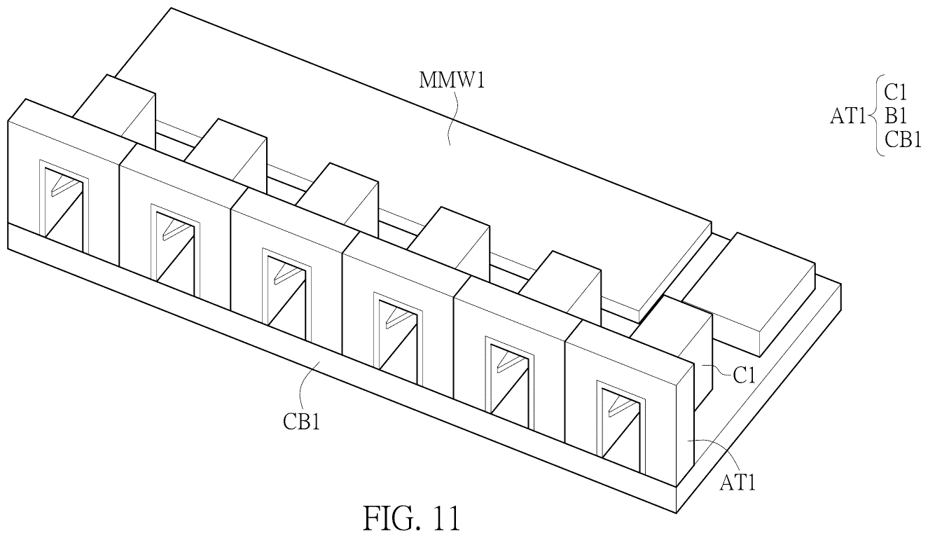

Referring to FIG. 10 and FIG. 11, FIG. 10 is a schematic diagram of an antenna device in accordance with the first embodiment of the present disclosure in combination with a millimeter wave module, and FIG. 11 is another schematic view of the antenna device in accordance with the first embodiment of the present disclosure in combination with a millimeter wave module.

In FIG. 10 and FIG. 11, the plurality of antenna devices AT1 can be arranged adjacent to each other, and the substrate assembly CB1 of the plurality of antenna devices AT1 can be arranged on the same circuit board. In addition, the millimeter wave module MMW1 can be arranged on the same side of the antenna device AT1 (FIG. 11) or on the opposite side (FIG. 10).

### Second Embodiment

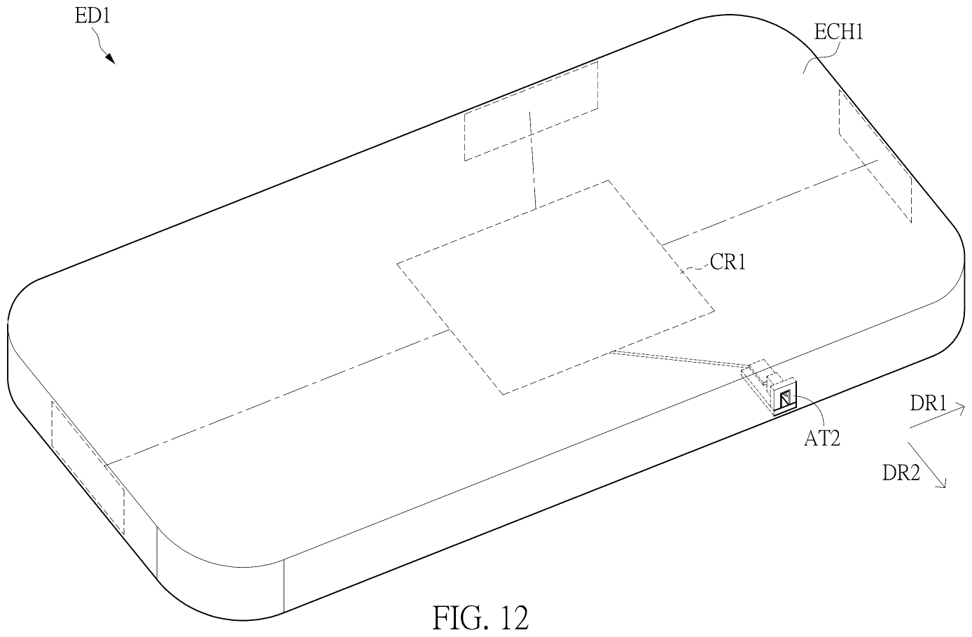

Referring to FIG. 12, FIG. 12 is a schematic view of an electronic device according to a second embodiment of the present disclosure.

In this embodiment, an electronic device ED1 is provided.

The electronic device ED1 includes a housing ECH1, a control circuit CR1 and an antenna device AT2. The control circuit CR1 and the antenna device AT2 are arranged in the housing ECH1.

The antenna device AT2 has the same structure and function as the antenna device AT1 in the first embodiment, and is omitted herein. The antenna device AT2 is electrically connected to the control circuit CR1 to receive an antenna signal. The antenna signal may be transmitted according to the location and direction of the antenna device AT2.

The electronic device ED1 is a smart phone, a tablet computer, a wearable electronic device or a desktop electronic device.

### Third Embodiment

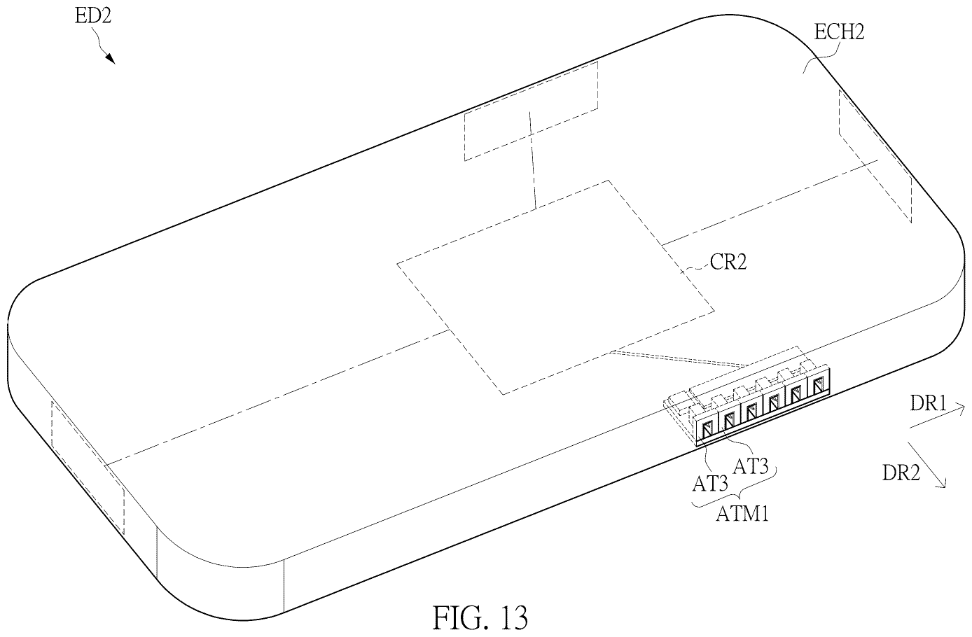

Referring to FIG. 13, FIG. 13 is a schematic view of an electronic device according to a third embodiment of the present disclosure.

In this embodiment, an electronic device ED2 is provided.

The electronic device ED2 includes a housing ECH2, a control circuit CR2 and an antenna module ATM1. The antenna module ATM1 and the control circuit CR2 are arranged in the housing ECH2. The antenna module ATM1 includes a plurality of antenna devices AT3.

The plurality of antenna devices AT3 of the antenna module ATM1 are electrically connected to the control circuit CR2 to receive antenna signals. The antenna signal can be transmitted according to the location and direction of the antenna device AT3.

The antenna device AT3 in this embodiment has the same structure and function as the antenna device AT1 in the first embodiment, and is omitted herein. However, the plurality of antenna devices AT3 of this embodiment are disposed adjacent to each other, and the opening directions of the shielding covers C1 and the frames B1 of the plurality of antenna devices AT3 are all oriented toward the same side. In addition, the height of the plurality of antenna devices AT3 in the antenna module ATM1 of this embodiment is less than 5 mm (substrate assembly CB1 (less than 1 mm)+shielding cover C1 (2.9 mm)+frame B1 (1 mm)<5 mm), which is very suitable for being set on the side of the electronic device ED2 for antenna signal transmission, and will not increase or affect the thickness of the electronic device ED2.

In this embodiment, the electronic device ED2 is a smart phone, a tablet computer, a wearable electronic device or a desktop electronic device.

### Fourth Embodiment

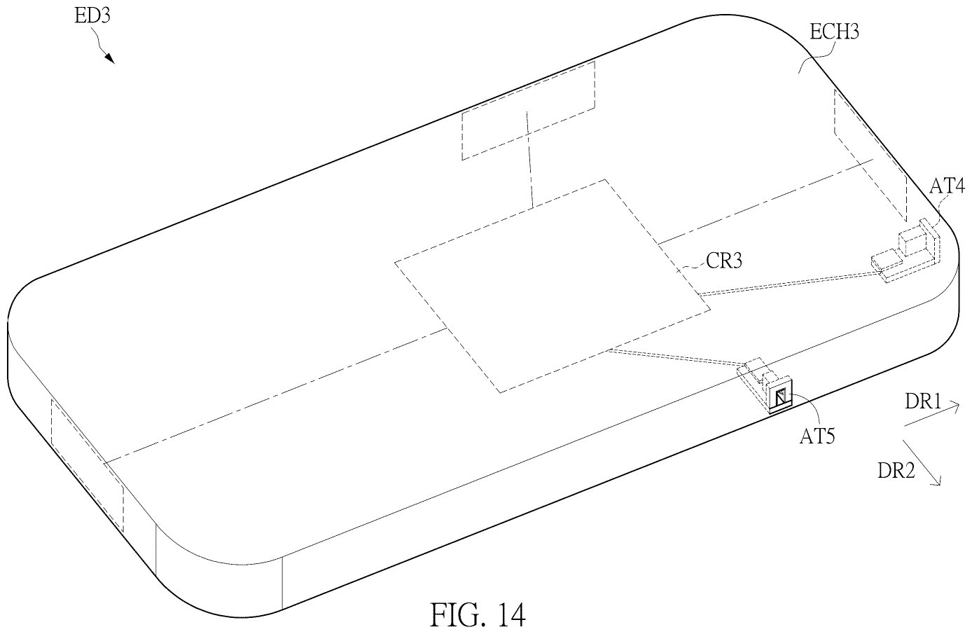

Referring to FIG. 14, FIG. 14 is a schematic view of an electronic device according to a fourth embodiment of the present disclosure.

In this embodiment, an electronic device ED3 is provided.

The electronic device ED3 includes a housing ECH3, a control circuit CR3, a first antenna device AT4 and a second antenna device AT5.

In this embodiment, the first antenna device AT4 and the second antenna device AT5 are electrically connected to the control circuit CR3 to receive antenna signals. Furthermore, the structures and functions of the first antenna device AT4 and the second antenna device AT5 are similar to those of the antenna device AT1 of the first embodiment, and are omitted herein. However, in this embodiment, the first antenna device AT4 and the second antenna device AT5 are arranged in different directions. The shielding cover C1 and the frame B1 of the first antenna device AT4 face a first direction DR1, and the shielding cover C1 and the opening of the frame B1 of the second antenna device AT5 face a second direction DR2.

That is, the antenna signal can be transmitted from the first antenna device AT4 facing the first direction DR1, or from the second antenna device AT5 facing the second direction DR2, thereby increasing the possible transmission directions of the antenna signal. In other embodiments, the first antenna device AT4 and the second antenna device AT5 can respectively receive antenna signals from different modules to perform signal transmission in different directions.

### Beneficial Effects of the Embodiments

In conclusion, the antenna device of the present disclosure utilizes a shielding cover design that is made by surface mounting technology to convert antenna signals (RF signals) from the inner layer circuits of the multi-layer circuit board in the substrate assembly to the waveguide structure on the substrate assembly. Next, the antenna device of the present disclosure converts the electromagnetic wave (electric field vector) of the antenna signal to radiate directly outward in the horizontal direction, and provides performance that is superior to that of an antenna-in-package.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna device, comprising:
a substrate assembly including a plurality of metal vias and at least one signaling metal via;
a first metal bending structure including a first portion and a second portion, wherein the second portion is connected to the first portion, the second portion is parallel to the substrate assembly, and the first portion is connected to and disposed on the substrate assembly;
a shielding cover being disposed on the substrate assembly and shielding the first metal bending structure, wherein a side of the shielding cover adjacent to the first portion of the first metal bending structure is closed, and another side of the shielding cover away from the first portion of the first metal bending structure is open and has an opening; and
a frame being disposed on the substrate assembly and being connected to the shielding cover;
wherein the substrate assembly is connected to a control circuit to receive an antenna signal, and the antenna signal is transmitted to the first metal bending structure through a signal metal through hole of the substrate assembly to adjust a transmission direction for transmission.

2. The antenna device according to claim 1, wherein the second portion of the first metal bending structure is a triangle or a trapezoid, and a width of the second portion of the first metal bending structure gradually decreases.

3. The antenna device according to claim 2, wherein one side of the first metal bending structure is connected to an inner wall of the shielding cover.

4. The antenna device according to claim 3, wherein the first portion of the first metal bending structure includes a first notch, the first notch is arranged on a side of the first portion connected to the substrate assembly, the first portion is divided into two parts according to the first notch, the first portion includes a first part and a second part, the second part of the first portion is connected to the inner wall of the shielding cover.

5. The antenna device according to claim 4, wherein the substrate assembly includes a multi-layer circuit board, a signal strip line, a soldering pad, at least one signaling metal via and a plurality of metal vias, the signal strip line is arranged on a middle layer of the multi-layer circuit board, the signal strip line is connected to the soldering pad through the signaling metal via, and the first part of the first portion is connected to the soldering pad to receive the antenna signal.

6. The antenna device according to claim 5, wherein the substrate assembly includes a first side and a second side, the plurality of metal vias on the first side of the substrate assembly are arranged symmetrically in pairs along a first direction, the plurality of metal vias on the second side of the substrate assembly are arranged in two rows along a second direction, and the first direction and the second direction are perpendicular to each other.

7. The antenna device according to claim 6, wherein the frame includes a frame width and a frame height, the shielding cover includes a shielding cover width and a shielding cover height, and wherein the frame width is the shielding cover width plus twice a predetermined width, the frame height is the shielding cover height plus a predetermined height, a width value of the predetermined width is 1 mm, a height value of the predetermined height is 1 mm, and the frame also includes a frame thickness, and a thickness value of the frame thickness is 1 mm.

8. An electronic device, comprising:
a control circuit; and
at least one antenna device, the at least one antenna device being electrically connected to the control circuit to receive an antenna signal, and the at least one antenna device including:
a substrate assembly including a plurality of metal vias and at least one signaling metal via;
a first metal bending structure including a first portion and a second portion, wherein the second portion connected to the first portion of the first metal bending structure, the second portion of the first metal bending structure is parallel to the substrate assembly, and the first portion of the first metal bending structure is connected to and disposed on the substrate assembly;
a shielding cover being disposed on the substrate assembly and shielding the first metal bending structure, wherein a side of the shielding cover adjacent to the first portion of the first metal bending structure is closed, and another side of the shielding cover away from the first portion of the first metal bending structure is open and has an opening; and
a frame being disposed on the substrate assembly and being connected to the shielding cover;
wherein the substrate assembly is connected to the control circuit to receive an antenna signal, and the antenna signal is transmitted to the first metal bending structure through the at least one signaling metal via of the substrate assembly to adjust a transmission direction for transmission.

9. An electronic device, comprising:
a control circuit;
a first antenna device being electrically connected to the control circuit to receive an antenna signal; and
a second antenna device being electrically connected to the control circuit to receive the antenna signal;
wherein the first antenna device and the second antenna device respectively include:
a substrate assembly including a plurality of metal vias and at least one signaling metal via;
a first metal bending structure including a first portion and a second portion, wherein the second portion of the first metal bending structure is connected to the first portion of first metal bending structure, the second portion is parallel to the substrate assembly, and the first portion of the first metal bending structure is connected to and disposed on the substrate assembly;
a shielding cover being disposed on the substrate assembly and shielding the first metal bending structure, wherein a side of the shielding cover close to the first portion of the first metal bending structure is closed, and another side of the shielding cover away from the first portion of the first metal bending structure is open and has an opening; and
a frame being disposed on the substrate assembly and being connected to the shielding cover;
wherein the antenna signal is transmitted to the first metal bending structure through a signal metal through hole of the substrate assembly to adjust a transmission direction for transmission;
wherein the antenna signal of the first antenna device is transmitted along a first direction, and the antenna signal of the second antenna device is transmitted along a second direction, and the first direction and the second direction are different directions.

10. The electronic device according to claim 9, wherein the first direction and the second direction are perpendicular to each other.
